(19) United States
(12) Patent Application Publication
(10) Pub. No.: US 2024/0303955 A1
(43) Pub. Date: Sep. 12, 2024

(54) OBJECTION DETECTION SYSTEM DEFINING A DYNAMIC REGION OF INTEREST

(71) Applicant: GM Global Technology Operations LLC, Detroit, MI (US)

(72) Inventor: Kamran Ali, Troy, MI (US)

(21) Appl. No.: 18/180,351

(22) Filed: Mar. 8, 2023

(51) Int. Cl. G06V 10/25; G01S 13/89; G01S 17/89; G06V 20/56; G06V 20/58

(52) U.S. Cl. CPC G06V 10/25; G01S 13/89; G01S 17/89; G06V 20/58; G06V 20/588

(57) ABSTRACT

An objection detection system for a vehicle includes one or more range sensors and one or more controllers in communication with the one or more range sensors. The one or more controllers execute instructions to instruct the one or more range sensors to emit a signal. The one or more range sensors receive a reflected signal from the environment surrounding the vehicle. The one or more controllers determine a position of the detected object based on the reflected signal and compare the position of the detected object with a dynamic region of interest (ROI). The one or more controllers determine the position of the detected object is outside of the dynamic ROI. In response to determining the position of the detected object is outside the dynamic ROI, the one or more controllers disregard the detected object for purposes of scene building.

### INTRODUCTION

The present disclosure relates to an objection detection system for a vehicle, where the objection detection system defines a dynamic region of interest (ROI) to reduce the likelihood of ghost detections.

An autonomous vehicle executes various tasks such as, but not limited to, perception, localization, mapping, path planning, decision making, and motion control. An autonomous vehicle may perceive objects in the surrounding environment by various perception sensors such as, for example, cameras, radar sensors, and LiDAR. Radar sensors are more robust against adverse weather conditions such as fog, snow, and rain when compared to cameras or LiDAR, however, radar data is also more suspectable to issues such as noise.

A radar sensor emits a signal and determines a speed and disposition of a target object based on an angle of arrival of a reflected signal, where the reflected signal is reflected by the target object. However, sometimes the reflected signal follows an indirect reflection path between the radar sensor and the target object, which may be referred to as multi-path propagation. The indirect reflection path results in ghost detections. Ghost detections are most common when the multi-path signals are reflected by a surface that appears flat relative to the signal emitted by the radar sensor. It is to be appreciated that the ghost detections may surpass various radar filters provided to discern between noise, clutter, and interference such as, for example, a constant false alarm rate (CFAR) filter. This is because the ghost detections have a similar frequency as the actual or valid reflections.

Thus, while current object detection systems achieve their intended purpose, there is a need in the art for an improved approach for managing ghost detections.

### SUMMARY

According to several aspects, an objection detection system for a vehicle is disclosed, and includes one or more range sensors that emit signals into in an environment surrounding the vehicle, and one or more controllers in communication with the one or more range sensors. The one or more controllers execute instructions to instruct the one or more range sensors to emit a signal. The one or more controllers receive, by the one or more range sensors, a reflected signal from the environment surrounding the vehicle, where the reflected signal originates from a detected object located in the environment surrounding the vehicle. The one or more controllers determine a position of the detected object based on the reflected signal. The one or more controllers compare the position of the detected object with a dynamic region of interest (ROI), where the dynamic ROI defines an area within the environment surrounding the vehicle containing objects material to the navigation of the vehicle. The one or more controllers determine the position of the detected object is outside of the dynamic ROI. In response to determining the position of the detected object is outside the dynamic ROI, the one or more controllers disregard the detected object for purposes of scene building.

In another aspect, the one or more controllers execute instructions to determine the position of the detected object is inside the dynamic ROI.

In yet another aspect, in response to determining the position of the detected object is located inside the dynamic ROI, the one or more controllers identify the detected object as relevant for purposes of scene building.

In an aspect, an outer perimeter of the area of the dynamic ROI is determined in part based on a field-of-view of the one or more range sensors.

In another aspect, the area of the dynamic ROI includes a portion of a road segment that the vehicle traverses while executing a maneuver associated with a direction of maneuver.

In yet another aspect, the one or more controllers execute instructions to define the area of the dynamic ROI to include lanes of the road segment where traffic flows in a direction having the potential to interfere with the vehicle as the vehicle executes a maneuver associated with a direction of maneuver.

In an aspect, the one or more controllers execute instructions to define the area of the dynamic ROI based on a geometry of a road segment where the vehicle is currently positioned.

In another aspect, the geometry of the road segment refers to one or more of the following: lane lines and lane boundaries.

In yet another aspect, the area of the dynamic ROI is defined based on speed limit of a road segment where the vehicle is currently positioned.

In an aspect, the area of the dynamic ROI is expanded as a speed limit decreases and contracts as the speed limit increases.

In another aspect, the one or more controllers execute instructions to define the area of the dynamic ROI include road markers located adjacent to a road segment where the vehicle is currently positioned.

In yet another aspect, the one or more controllers execute instructions to define the area of the dynamic ROI to include potential encounters with moving objects crossing a portion of a road segment where the vehicle is currently positioned.

In an aspect, the range sensors include one or more of the following: radar sensors and LiDAR.

A method for determining when an object detected by an objection detection system is relevant for purposes of scene building is disclosed. The method includes instructing, by one or more controllers, one or more range sensors to emit a signal. The method includes receiving, by the one or more range sensors, a reflected signal from an environment surrounding a vehicle, where the reflected signal originates from a detected object located in the environment surrounding the vehicle. The method includes determining a position of the detected object based on the reflected signal. The method includes comparing the position of the detected object with a dynamic ROI, where the dynamic ROI defines an area within the environment surrounding the vehicle containing objects material to the navigation of the vehicle. The method includes determining the position of the detected object is outside of the dynamic ROI. In response to determining the position of the detected object is outside the dynamic ROI, the method includes disregarding the detected object for purposes of scene building.

In another aspect, the method includes determining the position of the detected object is inside the dynamic ROI.

In yet another aspect, in response to determining the position of the detected object is located inside the dynamic ROI, the method includes identifying the detected object as relevant for purposes of scene building.

In an aspect, an objection detection system for a vehicle is disclosed, and includes one or more range sensors that emit signals into an environment surrounding the vehicle and one or more controllers in communication with the one or more range sensors, where the one or more controllers execute instructions to instruct the one or more range sensors to emit a signal. The one or more controllers receive, by the one or more range sensors, a reflected signal from the environment surrounding the vehicle, where the reflected signal originates from a detected object located in the environment surrounding the vehicle. The one or more controllers determine a position of the detected object based on the reflected signal. The one or more controllers compare the position of the detected object with a dynamic ROI, wherein the dynamic ROI defines an area within the environment surrounding the vehicle containing objects material to the navigation of the vehicle, and an outer perimeter of the area of the dynamic ROI is determined in part based on a field-of-view of the one or more range sensors. The one or more controllers determine the position of the detected object is outside of the dynamic ROI. In response to determining the position of the detected object is outside the dynamic ROI, the one or more controllers disregard the detected object for purposes of scene building. The one or more controllers determine the position of the detected object is inside the dynamic ROI, and in response to determining the position of the detected object is located inside the dynamic ROI, the one or more controllers identify the detected object as relevant for purposes of scene building.

In another aspect, the area of the dynamic ROI includes a portion of a road segment that the vehicle traverses while executing a maneuver associated with a direction of maneuver.

In yet another aspect, the one or more controllers execute instructions to define the area of the dynamic ROI to include lanes of the road segment where traffic flows in a direction having the potential to interfere with the vehicle as the vehicle executes a maneuver associated with a direction of maneuver.

In an aspect, the one or more controllers execute instructions to define the area of the dynamic ROI based on a geometry of a road segment where the vehicle is currently located, where the geometry of the road segment refers to one or more of the following: lane lines and lane boundaries.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed objection detection system having one or more controllers in electronic communication with one or more radar sensors, according to an exemplary embodiment;

FIG. 2 illustrates the vehicle in an environment including a four-way intersection, where a dynamic region of interest (ROI) is determined by the objection detection system, according to an exemplary embodiment;

FIG. 3 illustrates the vehicle in another environment that is a school zone with the dynamic ROI, according to an exemplary embodiment; and

FIG. 4 is a process flow diagram illustrating a method for determining if a detected object is relevant for purposes of scene building based on the dynamic ROI, according to an exemplary embodiment.

### DETAILED DESCRIPTION

The following description is merely exemplary in nature and is not intended to limit the present disclosure, application, or uses.

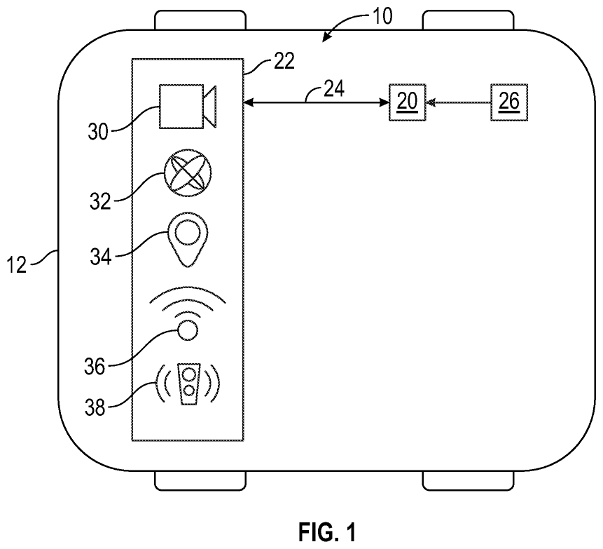

Referring to FIG. 1, an exemplary objection detection system 10 for a vehicle 12 is illustrated. It is to be appreciated that the vehicle 12 may be any type of vehicle such as, but not limited to, a sedan, truck, sport utility vehicle, van, or motor home. In one embodiment, the object detection system 10 is part of an automated driving system (ADS) or an advanced driver assistance system (ADAS) for assisting a driver with steering, braking, and/or accelerating. The objection detection system 10 includes one or more controllers 20 in electronic communication with a plurality of perception sensors 22 for receiving perception data 24. The plurality of perception sensors 22 include one or more cameras 30, an inertial measurement unit (IMU) 32, a global positioning system (GPS) 34, one or more radar sensors 36, and LiDAR 38, however, is to be appreciated that additional sensors may be used as well. The one or more controllers 20 receive map data 26 as well. In an embodiment, the map data 26 may be high-definition map data that enables lane-level or higher accuracy for localization purposes, however, it is to be appreciated that standard map data 26 may be used as well.

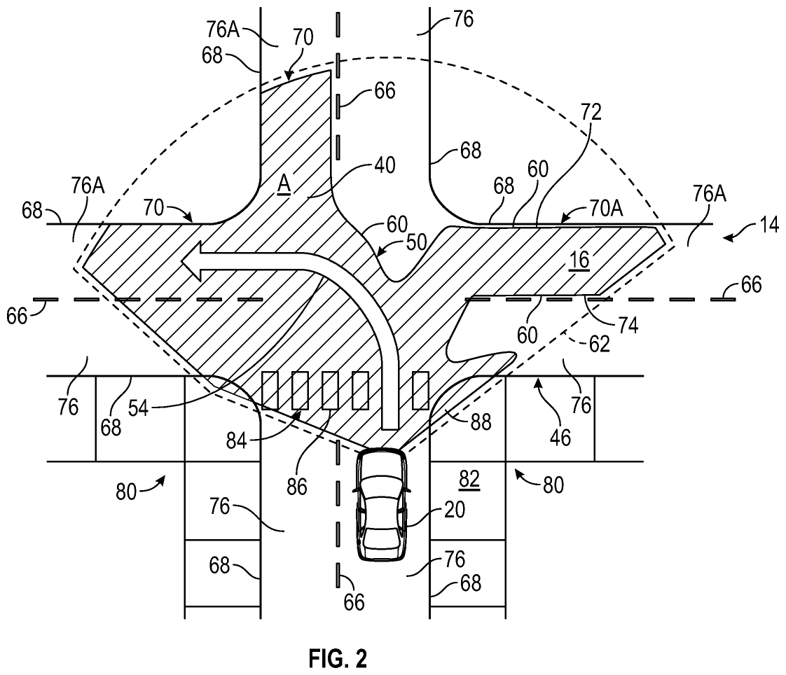

FIG. 2 is an illustration of the vehicle 12 traveling along a road 16 navigating an environment 14 that surrounds the vehicle 12. Referring to FIGS. 1 and 2, as explained below the objection detection system 10 determines a dynamic region of interest (ROI) 40 that defines an area A within the environment 14 surrounding the vehicle 12 containing objects that are material when navigating the vehicle 12. The area A of the dynamic ROI 40 is calculated dynamically in real-time to reflect changes in various driving conditions and scenarios as the vehicle 12 travels along the road 16. The objection detection system 10 disregards detected objects positioned outside of the dynamic ROI 40 for purposes of scene building. It is to be appreciated that disregarding detected objects located outside of the dynamic ROI 40 reduces the likelihood of ghost detections.

Both the one or more radar sensors 36 and the LiDAR 38 are referred to as range sensors for detecting a presence of and a position of objects. The one or more controllers 20 instruct the one or more range sensors (i.e., the one or more radar sensors 36, the LiDAR 38, or both) to emit a signal. The one or more range sensors receive a reflected signal from the environment 14 surrounding the vehicle 12, where the reflected signal originates from a detected object located in the environment 14 surrounding the vehicle. The one or more controllers 20 determine a position of the detected object based on information from the reflected signal. For example, if the range sensor is the one or more radar sensors 36, then an angle-of-arrival and a time-of-arrival of the reflected signal may be used to determine the position of the detected object. The one or more controllers 20 compare the position of the detected object with the dynamic ROI 40. In response to determining the position of the detected object is outside the dynamic ROI 40, the one or more controllers 20 disregard the detected object for purposes of scene building. As mentioned above, disregarding detected objects located outside of the dynamic ROI 40 reduces the likelihood of ghost detections by the objection detection system 10. However, in response to determining the position of the detected object is inside the dynamic ROI 40, the one or more controllers 20 identify the detected object as relevant for purposes of scene building.

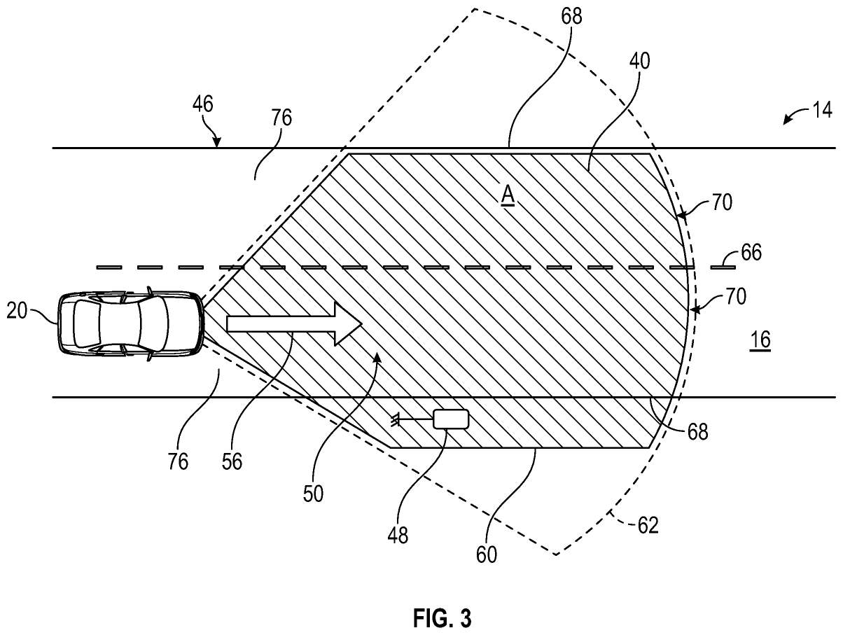

Continuing to refer to FIGS. 1 and 2, the area A of the dynamic ROI 40 is defined based on a plurality of factors, which are explained below. As seen in FIG. 2, the area A of the dynamic ROI 40 is defined by an outer perimeter 60, where objects located within the outer perimeter 60 of the area A of the dynamic ROI 40 are considered material to the navigation of the vehicle 12. One of the factors for defining the area A of the dynamic ROI 40 is a field-of-view 62 of the one or more range sensors. As seen in FIG. 2, the field-of-view 62 acts as a boundary that limits or restricts the outer perimeter 60 of the area A of the dynamic ROI 40. In addition to the field-of-view 62 of the one or more range sensors, the plurality of factors include, but are not limited to, a direction of maneuver of the vehicle 12, a geometry of a road segment 46 where the vehicle 12 is currently positioned, a speed limit the road segment 46, road markers 48 (FIG. 3) located adjacent to the road segment 46, potential encounters with other road users traveling along the road segment 46, and potential encounters with moving objects crossing a portion of the road segment 46.

In the example as shown in FIG. 2, the road segment 46 includes a four-way intersection. In the example as shown in FIG. 3, the road segment 46 include a straight section of road 16 that is part of a school zone. In the embodiment as shown in FIG. 3, the school zone is indicated by the road marker 48 located adjacent to the road segment 46. It is to be appreciated that the dynamic ROIs 40 illustrated in FIGS. 2 and 3 are merely exemplary in nature, and the specific configuration of the area A of the dynamic ROI 40 is determined based on the plurality of factors.

Referring now to FIGS. 1-3, the direction of maneuver of the vehicle 12 refers to a direction of travel of an imminent maneuver that the vehicle 12 is about to execute. In an embodiment, the direction of maneuver indicates a left turn, a right turn, proceed straight, or a U-turn, where the U-turn refers to a one-hundred-and-eighty-degree rotation to reverse the direction of travel for the vehicle 12. The one or more controllers 20 select the area A of the dynamic ROI 40 to include a portion 50 of the road segment 46 that the vehicle 12 traverses while executing a maneuver associated with direction of maneuver. In the example as shown in FIG. 2, the direction of maneuver indicates a left-hand turn, which is indicated by an arrow 54. Thus, the area A of the dynamic ROI 40 is selected to include the portion 50 of the road segment 46 that the vehicle 12 traverses while executing the left-hand turn 54. However, in the example as shown in FIG. 3, the direction of maneuver is proceeding in a straight line, which is indicated by the arrow 56. The area A of the dynamic ROI 40 is selected to include the portion 50 of the road segment 46 that the vehicle 12 traverses while proceeding in the straight line 56.

In an embodiment, the one or more controllers 20 define the area A of the dynamic ROI 40 based on the geometry of the road segment 46 that the vehicle 12 is located at as well, where the geometry of the road segment 46 refers to the lane lines 66 that separate different lanes 76 of travel and lane boundaries 68. The lane boundaries 68 indicate where the road segment 46 terminates or ends. Specifically, the area A of the dynamic ROI 40 includes one or more sections 70 of the road segment 46, where the sections 70 of the road segment 46 are divided based on the lane lines 66 and the lane boundaries 68.

As seen in FIG. 2, the outer perimeter 60 of the area A of the dynamic ROI 40 is defined in part by the one or more sections 70 of the road segment 46. For example, as seen in FIG. 2 the outer perimeter 60 of the area A of the dynamic ROI 40 is defined in part by the section 70A of the road segment 46. The section 70A of the road segment 46 is defined by a lane boundary 68 along an upper side 72 of the section 70A and the lane lines 66 along a lower side 74 of the section 70A. In the example as shown in FIG. 3, the area A of the dynamic ROI 40 extends past the lane boundaries 68 along the rightmost lane 76 to capture the road marker 48 positioned adjacent to the rightmost lane 76.

In an embodiment, the one or more controllers 20 define the area A of the dynamic ROI 40 based on the speed limit of the road segment 46 where the vehicle 12 is currently positioned as well, where the speed limit may be inferred by the road marker 48. For example, the road marker 48 may be a speed limit sign or a sign indicating reduced speed is required, such as a school zone. The area A of the dynamic ROI 40 is expanded as the speed limit decreases and contracts as the speed limit increases. Referring specifically to FIG. 2, the area A of the dynamic ROI 40 is expanded or contracted to either include or exclude regions 80 located directly adjacent to the road segment 46 having the potential to contain moving objects such as, for example, pedestrians, animals, and bicyclists. In the example as shown in FIG. 2, the region 80 includes a sidewalk 82, however, it is to be appreciated that FIG. 2 is merely exemplary in nature and the region 80 may not include a sidewalk 82 as well.

In an embodiment, the one or more controllers 20 define the area A of the dynamic ROI 40 to include the road markers 48 (FIG. 3) located adjacent to the road segment 46. In the example as shown in FIG. 3, the road marker 48 is a road sign indicating a school zone, however, it is to be appreciated that the road marker 48 may represent any type of road marker 48 provided to convey information to vehicles such as, for example, speed limit signs, stop signs, bus stop signs, and construction zone signs. As seen in FIG. 3, the area A of the dynamic ROI 40 is defined to include the road marker 48.

In one embodiment, the one or more controllers 20 define the area A of the dynamic ROI 40 to include potential encounters with other road users traveling along the road segment 46. The road users include, but are not limited to, vehicles, bicyclists, and animals. Specifically, the area A of the dynamic ROI 40 is defined to include lanes 76 of the road segment 46 where traffic flows in a direction having the potential to interfere with the vehicle 12 as the vehicle 12 executes the maneuver associated with the direction of maneuver. In the example as shown in FIG. 2, three of the right-hand lanes 76A that are part of the four-way intersection of the road segment 46 are included as part of the area A of the dynamic ROI 40. This is because road users traveling in the right-hand lanes 76A have the potential to interfere with the vehicle 12 as the vehicle 12 executes the left-hand turn 54.

In an embodiment, the one or more controllers 20 define the area A of the dynamic ROI 40 to include potential encounters with moving objects crossing a portion of the road segment 46. As mentioned above, the moving objects include, but are not limited to, pedestrians, animals, and bicyclists. Specifically, the area A of the dynamic ROI 40 is defined to include areas 84 allocated for the moving objects (e.g., pedestrians) to cross the road segment 46. In the example as shown in FIG. 2, the area of the road segment 46 allocated for the moving objects to cross the road segment 46 is a crosswalk 86. In addition to the crosswalk 86, the areas 84 allocated for the moving objects to cross the road segment 46 includes portions 88 of the region 80 located directly adjacent to the road segment 46 having the potential to contain the moving objects as well. In the example as shown in FIG. 2, portions 88 of the sidewalk 82 are also included as part of the area A of the dynamic ROI 40.

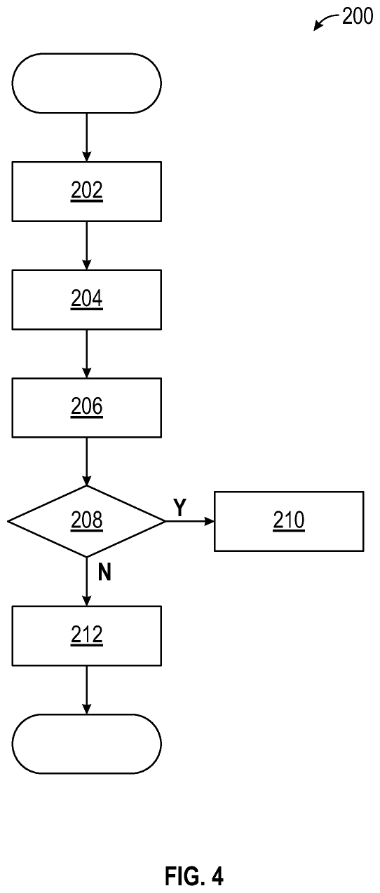

FIG. 4 is a process flow diagram illustrating a method 200 for determining when an object detected by the objection detection system 10 is relevant for purposes of scene building. Referring generally to FIGS. 1-4, the method 200 may begin at block 202. In block 202, the one or more controllers 20 instruct the one or more range sensors to emit a signal. The method 200 may then proceed to block 204.

In block 204, the one or more range sensors receive a reflected signal from the environment 14 surrounding the vehicle 12. As mentioned above, the reflected signal originates from a detected object located in the environment 14 surrounding the vehicle 12. The method 200 may then proceed to block 206.

In block 206, the one or more controllers 20 determine a position of the detected object based on the reflected signal. The method 200 may then proceed to decision block 208.

In decision block 208, the one or more controllers 20 compare the position of the detected object with the dynamic ROI 40, where the dynamic ROI 40 defines the area A within the environment 14 surrounding the vehicle 12 containing objects material to the navigation of the vehicle 12. If the one or more controllers 20 determine the position of the detected object is outside of the dynamic ROI 40, then the method 200 proceeds to block 210.

In block 210, in response to determining the position of the detected object is outside the dynamic ROI 40, the one or more controllers 20 disregard the detected object for purposes of scene building. The method 200 may then terminate.

Referring to decision block 208, if the one or more controllers 20 determine the position of the detected object is inside the dynamic ROI 40, then the method proceed to block 212.

In block 212, in response to determining the position of the detected object is located inside the dynamic ROI 40, the one or more controllers 20 identify the detected object as relevant for purposes of scene building. The method 200 may then terminate.

Referring generally to the figures, the disclosed object detection system provides various technical effects and benefits. Specifically, the object detection system only considers the detected objects located within the dynamic region of interest, thereby reducing the likelihood for ghost detections, and results in less confusion for algorithms related to autonomous driving and other related systems. Furthermore, the object detection system also results in less data that requires processing, which also leads to simpler data uploads for map construction. It is to be appreciated that less data results in less communication overhead, as resources are not used on processing noisy data points.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An objection detection system for a vehicle, comprising:
one or more range sensors that emit signals into in an environment surrounding the vehicle; and
one or more controllers in communication with the one or more range sensors, wherein the one or more controllers execute instructions to:
instruct the one or more range sensors to emit a signal;
receive, by the one or more range sensors, a reflected signal from the environment surrounding the vehicle, wherein the reflected signal originates from a detected object located in the environment surrounding the vehicle;
determine a position of the detected object based on the reflected signal;
compare the position of the detected object with a dynamic region of interest (ROI), wherein the dynamic ROI defines an area within the environment surrounding the vehicle containing objects material to the navigation of the vehicle;
determine the position of the detected object is outside of the dynamic ROI; and
in response to determining the position of the detected object is outside the dynamic ROI, disregard the detected object for purposes of scene building.

2. The objection detection system of claim 1, wherein the one or more controllers execute instructions to:
determine the position of the detected object is inside the dynamic ROI.

3. The objection detection system of claim 2, wherein the one or more controllers execute instructions to:
in response to determining the position of the detected object is located inside the dynamic ROI, identify the detected object as relevant for purposes of scene building.

4. The objection detection system of claim 1, wherein an outer perimeter of the area of the dynamic ROI is determined in part based on a field-of-view of the one or more range sensors.

5. The objection detection system of claim 1, wherein the area of the dynamic ROI includes a portion of a road segment that the vehicle traverses while executing a maneuver associated with a direction of maneuver.

6. The objection detection system of claim 5, wherein the one or more controllers execute instructions to:
define the area of the dynamic ROI to include lanes of the road segment where traffic flows in a direction having the potential to interfere with the vehicle as the vehicle executes a maneuver associated with a direction of maneuver.

7. The objection detection system of claim 1, wherein the one or more controllers execute instructions to:
define the area of the dynamic ROI based on a geometry of a road segment where the vehicle is currently positioned.

8. The objection detection system of claim 7, wherein the geometry of the road segment refers to one or more of the following: lane lines and lane boundaries.

9. The objection detection system of claim 1, wherein the area of the dynamic ROI is defined based on speed limit of a road segment where the vehicle is currently positioned.

10. The objection detection system of claim 1, wherein the area of the dynamic ROI is expanded as a speed limit decreases and contracts as the speed limit increases.

11. The objection detection system of claim 1, wherein the one or more controllers execute instructions to:
define the area of the dynamic ROI include road markers located adjacent to a road segment where the vehicle is currently positioned.

12. The objection detection system of claim 1, wherein the one or more controllers execute instructions to:
define the area of the dynamic ROI to include potential encounters with moving objects crossing a portion of a road segment where the vehicle is currently positioned.

13. The objection detection system of claim 1, wherein the range sensors include one or more of the following: radar sensors and LiDAR.

14. A method for determining when an object detected by an objection detection system is relevant for purposes of scene building, the method comprising:
instructing, by one or more controllers, one or more range sensors to emit a signal;
receiving, by the one or more range sensors, a reflected signal from an environment surrounding a vehicle, wherein the reflected signal originates from a detected object located in the environment surrounding the vehicle;
determining a position of the detected object based on the reflected signal;
comparing the position of the detected object with a dynamic ROI, wherein the dynamic ROI defines an area within the environment surrounding the vehicle containing objects material to the navigation of the vehicle;
determining the position of the detected object is outside of the dynamic ROI; and
in response to determining the position of the detected object is outside the dynamic ROI, disregarding the detected object for purposes of scene building.

15. The method of claim 14, further comprising:
determining the position of the detected object is inside the dynamic ROI.

16. The method of claim 15, further comprising:
in response to determining the position of the detected object is located inside the dynamic ROI, identifying the detected object as relevant for purposes of scene building.

17. An objection detection system for a vehicle, comprising:
one or more range sensors that emit signals into an environment surrounding the vehicle;
one or more controllers in communication with the one or more range sensors, wherein the one or more controllers execute instructions to:
instruct the one or more range sensors to emit a signal;
receive, by the one or more range sensors, a reflected signal from the environment surrounding the vehicle, wherein the reflected signal originates from a detected object located in the environment surrounding the vehicle;
determine a position of the detected object based on the reflected signal;
compare the position of the detected object with a dynamic region of interest (ROI), wherein the dynamic ROI defines an area within the environment surrounding the vehicle containing objects material to the navigation of the vehicle, and wherein an outer perimeter of the area of the dynamic ROI is determined in part based on a field-of-view of the one or more range sensors;
determine the position of the detected object is outside of the dynamic ROI;
in response to determining the position of the detected object is outside the dynamic ROI, disregard the detected object for purposes of scene building;
determine the position of the detected object is inside the dynamic ROI; and
in response to determining the position of the detected object is located inside the dynamic ROI, identify the detected object as relevant for purposes of scene building.

18. The objection detection system of claim 17, wherein the area of the dynamic ROI includes a portion of a road segment that the vehicle traverses while executing a maneuver associated with a direction of maneuver.

19. The objection detection system of claim 18, wherein the one or more controllers execute instructions to:
define the area of the dynamic ROI to include lanes of the road segment where traffic flows in a direction having the potential to interfere with the vehicle as the vehicle executes a maneuver associated with a direction of maneuver.

20. The objection detection system of claim 17, wherein the one or more controllers execute instructions to:
define the area of the dynamic ROI based on a geometry of a road segment where the vehicle is currently located, wherein the geometry of the road segment refers to one or more of the following: lane lines and lane boundaries.
